(19) United States
(12) Patent Application Publication
(10) Pub. No.: US 2017/0014207 A1
(43) Pub. Date: Jan. 19, 2017

(54) Self-ligating orthodontic brace and set comprising a plurality of such braces

(71) Applicant: JLH, Liffre (FR)

(72) Inventor: Jean-Christophe Merly, Liffre (FR)

(21) Appl. No.: 14/877,122

(22) Filed: Oct. 7, 2015

(30) Foreign Application Priority Data
Jul. 16, 2015 (FR) 1556712

(51) Int. Cl. A61C 7/28

(52) U.S. Cl. CPC A61C 7/287

(57) ABSTRACT

A self-ligating orthodontic brace comprising a base, a body, a groove that is configured to receive an orthodontic archwire and has an opening emerging in the direction of the occlusion plane, and a movable element for closing the groove that is configured to move between a position of closing and a position of opening the groove. The brace comprises a single lock for the movable element in the position of closing and also comprising a holder to hold the movable element in the position of opening the groove.

### CROSS-REFERENCES TO RELATED APPLICATIONS

This application claims the benefit of the French patent application No. 1556712 filed on Jul. 16, 2015, the entire disclosures of which are incorporated herein by way of reference.

### BACKGROUND OF THE INVENTION

The present invention relates to the technical field of orthodontic treatment devices and relates to a self-ligating orthodontic brace, and an assembly comprising a plurality of such braces.

Orthodontics is a dental medicine specialty, the purpose of which is to correct the postures and orientations of the jaw and/or teeth. To do this, practitioners use specific devices, such as dental appliances, which are composed of braces known in the technical field by the term “brackets”.

In the composition of the dental appliance, braces are bonded to teeth to be treated and connected together by an orthodontic archwire, such as a mechanical wire. The position of the teeth or their orientation is corrected through the forces applied to the teeth by means of the orthodontic archwire.

Well-known orthodontic braces are of the type comprising a body that is fixed to a tooth and has a groove in which the orthodontic archwire or wire is fitted. Fins are provided for holding the archwire in the groove by means of fasteners, such as elastomeric ligature wires or metal strands. The groove receiving the orthodontic archwire has a round, square or rectangular cross section. This category of brace has several drawbacks, including the friction generated between the fasteners and the orthodontic archwire, which requires the application of high forces to move the teeth. The result is a certain amount of discomfort for the patients and more lengthy treatment.

Another category of orthodontic brace is that of so-called self-ligating braces. Self-ligating braces comprise a means for closing the groove that is an element able to move between a so-called closing position in which it closes off access to the groove and a so-called opening position in which it releases access to the groove. In such self-ligating braces, the groove is the part that receives the orthodontic archwire and is closed by the closing means.

Compared with the previous category, these self-ligating braces have a certain number of advantages. In particular, they do not require the use of excessively high forces during treatment and cause less friction. They are, in addition, much easier to use for the practitioner, resulting in a shorter time in the chair for the patient and a reduced treatment period. They have better hygiene conditions since they retain less dental plaque and food. The so-called active self-ligating braces and the so-called passive self-ligating braces are classified in this category.

In an active self-ligating brace, the movable closing element is provided with elastic properties and holds and presses the archwire in the bottom of the groove, while allowing expression of the elasticity of the archwire, but also increasing the friction between the archwire and the groove during dental translation.

In a passive self-ligating brace, the movable element behaves as the fourth wall of the groove, thus allowing closure thereof without the orthodontic archwire being totally constrained at the bottom thereof. This configuration allows improved sliding of the archwire in the groove but reduces the expression of the elasticity of the archwire when its dimensions are less than those of the groove.

Among the braces used in orthodontic treatment, those where the insertion of the archwire is said to be “horizontal” and those where the insertion of the archwires is said to be “vertical” are also distinguished. The distinction is made according to the orientation of the opening of the groove which is, in the case of horizontal insertion, oriented in the vestibular-lingual or anteroposterior axis and, in the case of vertical insertion, oriented in the gingival-occlusal plane, when the brace is placed in the mouth of a patient.

Insertion of the archwire on a horizontal plane in the groove requires a greater thickness of the body of the brace than when the insertion is carried out vertically. This characteristic generates friction against the buccal mucosa and discomfort for the patient as well as reduced aesthetic appeal. In addition, this characteristic has an unfavorable influence on the correction of the rotations of the dental elements using small wires.

Numerous self-ligating braces are known at the present time Unfortunately, they often have mechanisms that are complex to machine, to manufacture or to manipulate. In addition, they are not completely effective in reducing the phenomena of friction between them and the orthodontic archwire.

By way of example, the European Patent Application published under the number EP 2 392 288 describes a self-ligating brace 1 comprising a base 2 having a face for fixing to the surface of a tooth (FIGS. 12 to 16). A body 3 extends from the base and has a groove 4 that opens in the direction of the occlusion plane PO and is intended to house an orthodontic archwire by so-called vertical insertion, that is to say in the gingival-occlusal axis. The brace 1 comprises a means 5 for closing the groove 4 that is an element able to move between a closing position in which it closes the groove (FIGS. 13, 16) and an opening position in which it leaves clear access to the groove 4 (FIGS. 12, 15). The movable closing element 5 is in the overall form of a U. In the closing position, a first arm 51 of the U closes the groove while the second arm 52 is situated opposite the groove 4 with respect to the first arm. The surface of contact between the archwire and the closing means is large, which increases the phenomena of friction with the body 3 and reduces the efficacy of the dental movement, giving rise to more lengthy treatment. Since the arms 51, 52 are situated one above the other in the closing position, there exists a constraint of minimum height (h) of the brace 1 and minimum depth (p) of the groove 4 in order to be able to house the arms and the orthodontic archwire. The brace is thereby too bulky and tends to be situated close to the gum. The result is a risk of inflammation of the gum by accumulation of food between the brace and the gum. Furthermore, an excessively large volume is detrimental to aesthetic appeal and comfort. Moreover, the closing means 5 is relatively narrow compared with the body 3 and does not close the groove 4 over its entire length (FIGS. 15, 16). Consequently there exists a risk of tilting movement of the brace when it moves on the orthodontic archwire during treatment. Beyond a critical angular formation, a phenomenon of buttressing and blocking of the movement of the brace along the archwire occurs. The movable element 5 has a means for locking in the closing position in the form of two wings 53, 54 provided on the second arm 52 and separated from each other by an empty space, each wing encountering a stop 6 on the body 3 in this closing position (FIG. 16). This locking means is not completely effective since the movable element 5 can shift slightly. When the movable element 5 passes from the closing position to the opening position, a force must be applied to the movable element so that the wings 53, 54 of the second arm 52 converge towards each other so as to pass the stop 6. Applying this force by means of a manipulation tool is not easy and a risk of detachment of the brace from the tooth is observed. The movable element 5 has moreover a means for holding in the opening position, preventing the movable element from falling into the oral cavity. This holding means, which differs from the locking means, is provided on the first arm 51 in the form of a rectangular slot 55 able to slide along a guide 7 on the body (FIGS. 14, 15). It is difficult or even impossible to completely remove the movable closing element 5 if replacement thereof is necessary.

### SUMMARY OF THE INVENTION

One of the aims of the present invention is to propose a self-ligating brace with vertical insertion of the orthodontic archwire, in particular of the passive type, which is simple in design and use and as inexpensive as possible, which shows itself to be effective in the treatment of the positions and orientations of the teeth, which is the most discrete possible, that is to say, which has good aesthetic characteristics, which has reduced size, which has a smooth anterior or labial face and which has as little roughness and means for holding food or dental plaque as possible. Moreover, it would be advantageous to have means for locking and holding the movable closing element that is simpler, stronger and easier to manipulate and which does not impair the efficacy of treatment of movement and orientation of the teeth.

To this end, the invention relates to a self-ligating orthodontic brace intended to be fixed to the surface of a tooth of a patient, of the type comprising:
a base having a face for fixing to the surface of a tooth,
a body extending from the base, having an anterior face opposite to the fixing face, two lateral faces and a posterior face connected to the base,
a groove intended to receive an orthodontic archwire, which is delimited by a bottom wall and two lateral walls, which passes right through the body from one of its lateral faces to the other, and which has an opening emerging in the direction of the occlusal plane when said brace is fixed to a tooth,
a movable element for closing the groove, which is an element able to move in translation between a position of closing the groove in which it closes off access to said groove and an opening position in which it releases access to said groove.

According to the invention, the brace is characterized in that,
the body comprises a posterior position connected to the base and an anterior portion that is opposite the base with respect to said groove, and through which a passage is provided for the movable element, the passage comprising an opening accessible from the anterior face of the body and an opening emerging in the direction of the groove,
the movable closing element is able to move in translation in the vestibular-lingual axis inside said passage and has an anterior wall from which there extend, in the same plane, two lateral arms serving as a guide for the movable element inside said passage and at least one central arm which comprises a means for locking the movable element in the position of closure of the groove, in which its anterior wall fits flush with the anterior face of the body, and a means for holding the movable element in the opening position in which it only partly projects from the anterior face of the body, said locking means and holding means being the same locking and holding means.

The brace according to the invention contains a reduced number of parts, which results in facilitating its manufacture, installation and use by the practitioner. It has a single-piece appearance which, when the movable element is in the closing position, has on its faces no asperity or roughness liable to impair the aesthetic appeal and liable to retain food. The anterior face of the body, which is the face visible from the outside of the mouth, appears perfectly smooth in this closing position. In the closing position, the means for locking and holding the movable element ensures perfect holding of the orthodontic archwire in the groove. In the opening position for the groove, the movable element is stopped in its travel by this same locking and holding means, thus preventing its falling into the mouth of the patient.

The opening of the groove for inserting the orthodontic archwire in the occlusion direction makes it possible to confer a thickness of the body of the brace less than the thickness of the braces where the groove opens in the horizontal, or vestibular-lingual, direction. This feature reduces the phenomena of friction against the lips.

The movement of the movable element inside the passage along the vestibular-lingual axis rather than a rotation facilitates manipulation and reduces the risks of injuries to the patient that would be liable to occur by sliding of a manipulation tool.

The use of the same means providing both the locking of the movable element in the position of closure of the groove and its holding in the opening position considerably limits the difficulties of manufacturing the brace and the number of elements necessary for its correct functioning.

Furthermore, the planar configuration of the movable closing element makes it possible to reduce the height of the brace.

In order to facilitate reading of the following description, the braces according to the invention are described in relation to the teeth on which they are intended to be fixed and thus in relation to the planes and axes normally used in dentistry. Thus, in the present application, the vestibular, labial or buccal face of a tooth means the face of the tooth situated at the external part of the dental arch and which is in contact with the cheeks or lips. The lingual face of a tooth means the dental face situated on the same side as the tongue, and therefore the face opposite to the vestibular face. Occlusion plane means the virtual surface on which the maxillary and mandibular occlusal surfaces meet each other when the mouth is closed. The occlusion plane is perpendicular to the planes containing the vestibular and lingual faces of a tooth. Thus the direction of the occlusion plane, or gingival-occlusal direction, means the direction extending from the gums towards the occlusion plane, parallel to the planes containing the vestibular and lingual faces of a tooth. In the usual language used by a person skilled in the art, the direction of the occlusion plane is often referred to as “the vertical.”

Advantageously, the posterior portion of the body has one or more housings having an entrance emerging in the direction of said groove and designed to house the free ends of the arms of the movable closing element when the latter is in the closing position.

The ends of the arms are thus in abutment in a portion of the body, which confers great stability on the movable element in the position of closing the groove.

According to one embodiment of the invention, the central arm of the movable closing element comprises, by way of locking and holding means, at its free end, at least one lug projecting from the face opposite to the bottom wall of the groove in the direction of the occlusion plane, the lug or lugs having a guide surface that is able to cooperate with the stops on the body, so as to guide the movable element from the opening position to the closing position, and a holding surface that is able to cooperate with said stop means on the body, so as to lock and hold the movable element in the closing position or in the opening position.

Advantageously, at least one of the stops with which the lug or lugs cooperates in the closing position is provided in the housing in the body.

Advantageously again, at least one of the stops with which the lug or lugs of the central arm cooperates in the opening position is provided at the entrance of the passage that emerges in the direction of the groove.

In such an embodiment of the invention, when the movable closing element is moved towards the closing position for the groove, that is to say in a vestibular-lingual direction when the brace is in the mouth of a patient, the lug or lugs present at the free end of this central arm will encounter and cooperate with one of the stops on the body. The guide surface of each lug enables the free end of the central arm to pass in the housing. The retaining surface is then situated against the stop and locks the movable element, which cannot move in the opposite direction, that is to say the lingual-vestibular direction.

According to one feature of the invention, the movable closing element has at least one means for attachment or gripping by a manipulation tool, in particular provided on the central arm of the movable element.

Advantageously, the movable element has two means for attachment or gripping by a manipulation tool, in the form of hollows or recesses, one passing through the anterior wall of the movable element, the other formed in the free end of the central arm.

Such a tool is used for exerting a slight pressure on the central arm in order to lift it and pull it in the lingual-vestibular direction. This allows passage of the lug above the stop and movement of the movable element from the closing position to the opening position.

According to one embodiment of the invention, the movable closing element has two lateral faces, the distance between these two faces being at least equal to 90% of the distance between the two lateral faces of the body.

The width of the movable element is such that it completely or almost completely closes the groove in the closing position. Such a feature also prevents tilting movement of the brace when it moves on the orthodontic archwire during the treatment period.

According to one embodiment of the invention, the lateral arms of the movable closing element have a cylindrical cross-section.

According to another embodiment of the invention, each lateral arm of the movable element has a plurality of faces, one face of which is situated opposite the bottom wall of the groove when the movable element is in the closing position and a face opposite to it, these two faces converging towards each other in a direction extending from the longitudinal median axis of the movable element in the direction of the outside.

This embodiment is particularly advantageous since it limits the surface of contact between the arms of the movable element and the dental archwire housed in the groove so as to limit rubbing.

Advantageously, the passage formed in the anterior portion of the body has a cross-section complementary to the cross-section of the movable element.

According to one embodiment of the invention, the passage formed in the anterior portion is closed laterally.

In this embodiment, the lateral faces of the lateral arms of the movable element are not flush with the lateral faces of the body.

According to one embodiment of the invention, the passage formed in the anterior portion is open laterally.

In this embodiment, the lateral faces of the lateral arms of the movable element are flush with the lateral faces of the body. This embodiment causes less friction when the movable element moves in the passage.

According to one embodiment of the invention, the part of the groove receiving the orthodontic archwire has a round, square or rectangular cross-section, preferentially square.

Advantageously, the anterior portion of the body has a secondary passage passing through it, with a preferentially cylindrical or round cross-section, extending from one lateral face of the body to the other, for passage of a secondary wire.

Advantageously again, the body has means for attachment or fixing, such as hooks or notches, for dental movement means other than the orthodontic arch.

It can be envisaged attaching or fixing, to the brace according to the invention, any known means, such as wires, small chains or elastic elements, participating in the correction of the position or angle of the teeth, in addition to the orthodontic archwire housed in the groove.

Finally, the invention relates to a set of self-ligating orthodontic braces, comprising at least two self-ligating orthodontic braces as described above.

### BRIEF DESCRIPTION OF THE DRAWINGS

The features of the invention mentioned above, as well as others, will emerge more clearly from a reading of the following description of an example embodiment, said description being given in relation to the accompanying drawings, among which:

FIG. 1A is a perspective view of an orthodontic brace according to a first embodiment of the invention, the movable closing element being in the position of closing the groove,

FIG. 1B is a perspective view of a movable closing element according to the first embodiment of the invention,

FIG. 2A is a perspective view of an orthodontic brace according to a second embodiment of the invention, the movable closing element being in the position of closing the groove,

FIG. 2B is a perspective view of a movable closing element according to the second embodiment of the invention,

FIG. 3 is a perspective view of an orthodontic brace according to a first embodiment of the invention, the movable closing element being in the position of opening the groove,

FIGS. 4 and 5 are profile views of an orthodontic brace according to a second embodiment of the invention, the movable closing element being in the position of opening the groove in FIG. 4 and in the position of closing of the groove in FIG. 5,

FIGS. 6A and 6B are profile cross-sectional views of an orthodontic brace according to a first embodiment of the invention, the movable closing element being in the position of opening the groove in FIG. 6A and in the position of closing the groove in FIG. 6B,

FIGS. 7A and 7E are schematic profile representations of an orthodontic brace according to the first embodiment of the invention, the movable closing element being in the position of opening the groove in FIGS. 7A and 7E, in the position of closing the groove in FIGS. 7C and 7D, and in the intermediate position in FIG. 7B,

FIG. 8 is a front view of an orthodontic brace according to the second embodiment of the invention, in the absence of a movable closing element,

FIG. 9 is a front view of an orthodontic brace according to the first embodiment of the invention, in the absence of a movable closing element,

FIG. 10 is a perspective front view of a movable closing element according to the first embodiment,

FIG. 11 is a view from below of a movable closing element according to the first embodiment,

FIGS. 12 and 13 are profile views of a self-ligating brace according to the prior art,

FIG. 14 is a perspective view of a movable closing element of the prior art,

FIGS. 15 and 16 are views in cross-section of a self-ligating brace according to the prior art, the closing element being in the position of opening the groove in FIG. 15 and in the closing position in FIG. 16.

### DETAILED DESCRIPTION OF THE PREFERRED EMBODIMENTS

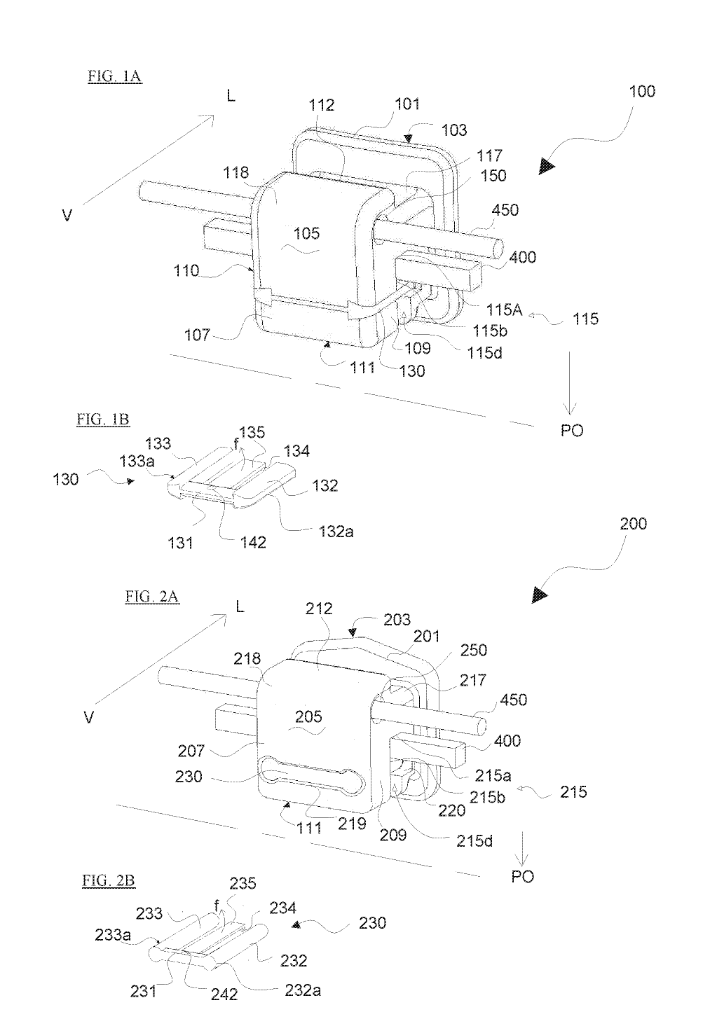

In relation to all of FIGS. 1 to 11, self-ligating orthodontic braces of the passive type according to a first embodiment 100 (FIGS. 1A, 1B, 3, 6A, 6B, 7A to 7D, 9, 10 and 11) and according to a second embodiment 200 (FIGS. 2A, 1B, 4, 5, 8) are shown.

As shown in particular in FIGS. 1A, 2A, 3 and 4, a self-ligating orthodontic brace of the passive type according the invention 100, 200 comprises a base 101, 201 having a face 103, 203 for fixing to the surface of a tooth. Such a brace is in particular intended to be fixed to the vestibular face of a tooth, that is to say the face of the tooth visible from the outside of the mouth of a patient. The brace can be fixed for example by gluing or any method well known to a person skilled in the art.

From the base 101, 201, a body 105, 205 extends, having an anterior face 107, 207 opposite to the fixing face 103, 203. The anterior face 107, 207 is the face of the brace 100, 200 that is visible from the outside of the mouth of a patient.

The body 105, 205 has two lateral faces 109, 209 and 110, 210, a bottom face 111, 211 and a top face 112, 212.

The top face 112, 212 is the face of the brace 100, 200 that is situated adjacent to the gums in the mouth of a patient. It is therefore a gingival face. The bottom face 111, 211 is the face of the brace 100, 200 that is situated opposite the occlusion plane PO of the mouth of the same patient (FIGS. 1A, 2A, 3, 4, 5).

The brace 100, 200 has a groove 115, 215 intended to receive an orthodontic archwire 400. The groove 115, 215 passes right through the body 105, 205 from one of its lateral faces 109, 209 as far as the other lateral face 110, 210. The cross-section of the groove in the braces 100 and 200 is rectangular.

The groove 115, 215 is delimited by a bottom wall 115a, 215a and two lateral walls 115b, 215b and 115c, 215c (FIGS. 1A, 2A and 6). The groove 115, 215 also has an opening 115d, 215d that emerges vertically in the direction of the occlusion plane PO when the brace 100, 200 is fixed to a tooth (see arrows in FIGS. 1A and 1B). The opening 115d, 215d enables the orthodontic archwire 400 to be inserted and housed in the groove 115, 215, against the bottom wall 115a, 215a.

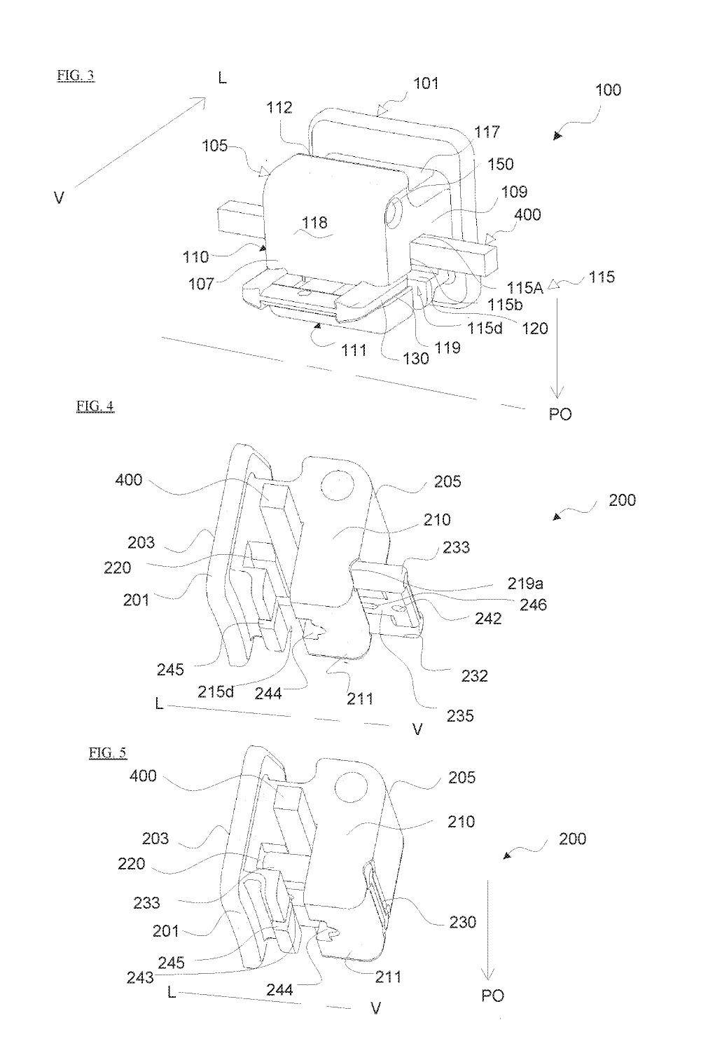

A movable element 130, 230 for closing the groove 115, 215, in particular visible in detail in FIGS. 1A, 1B, 10 and 11, is provided for holding the archwire 400 in place in the groove 115, 215. This is an element that is able to move in translation between a position of closing the groove 115, 215 in which it closes off access to the groove from the outside of the brace 100, 200 (FIGS. 1A, 2A, 5) and an opening position in which it leaves clear access to the groove (FIGS. 3, 4). In the closing position (FIGS. 1A, 2A) the archwire 400 is held in the groove 115, 215 and cannot escape therefrom through the opening 115d, 215d, which is closed by the closing means 130, 230. In the opening position (FIGS. 3 and 4) the archwire 400 can be dislodged from the groove 115, 215 by passing through the opening 115d, 215d, which is therefore not closed off by the closing means 130, 230.

According to the invention, a passage 119, 219 for the movable closing element 130, 230 is provided through an anterior portion 118, 218 of the body 105, 205. This anterior portion 118, 218 is opposite the base 101, 201 with respect to the groove 115, 215. The passage 119, 219 for the movable closing element 130, 230 provided through the anterior portion 118, 218 comprises an opening 119a, 218a accessible from the anterior face 107, 207 of the body and an opening 119b, 219b that emerges in the groove 115, 215 (FIGS. 4, 5, 6, 8, 9, in particular). In this way, inside the passage 119, 219, the movable closing element 130, 230 can be able to move in translation in the vestibular-lingual axis (V-L) between the closing and opening positions.

Furthermore, the body comprises a posterior portion 117, 217 adjacent to the base 101, 201 or in line therewith. The posterior portion 117, 217 has a housing 120, 220 that comprises a bottom wall, such as the bottom wall 121, and which emerges and opens out in the groove 115, 215, in the lingual-vestibular direction, and is situated in the axis of the passage 119, 219, in particular in the axis of the opening 119b, 219b (FIGS. 3, 4, 5, 7).

The movable closing element 130, 230 has an anterior wall 131, 231 from which there extend, in the same plane, two lateral arms 132, 232 and 133, 233, the lateral arms each having free ends (FIGS. 1B, 2B, 10, 11). The lateral arms 132, 232 and 133, 233 serve as a guide for the movable element 130, 230 in the passage 119, 219.

The movable closing element 130, 230 also has a central arm 135, 235 that supports a locking and holding means 134, 234 for firstly locking the movable element 130, 230 in the position of closure of the groove 115, 215 and secondly holding the movable element 130, 230 in the opening position. A single means is thus used for holding the movable element 130, 230 in the two positions, that is to say opening and closing.

The central arm 135, 235 is produced from a material conferring on it elastic properties allowing slight bending in a direction extending on either side of the plane containing all the arms 132, 133 and 135 of the element 130 and 232, 233 and 235 of the element 230 (arrows f, FIGS. 1B, 2B).

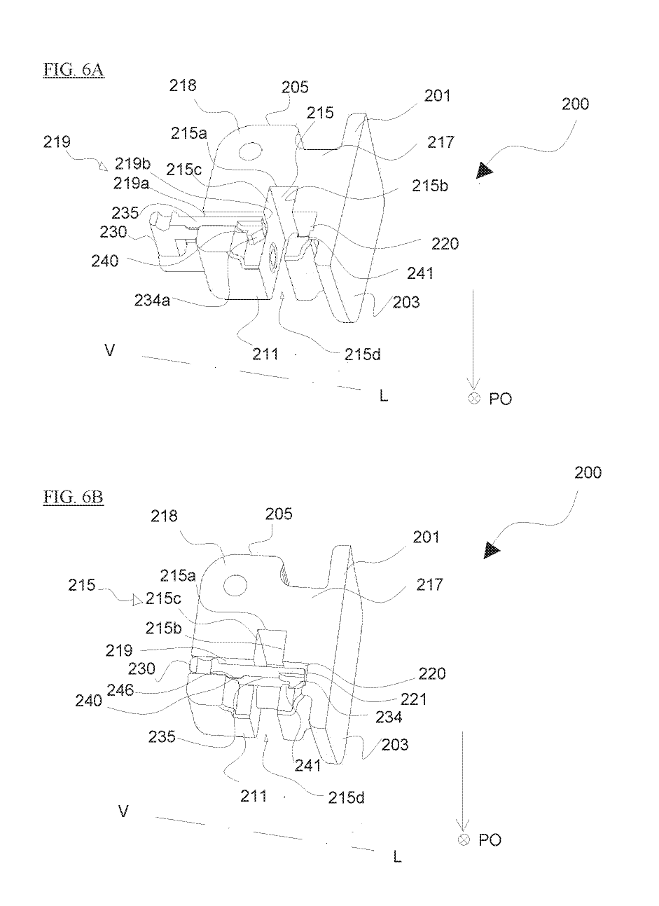

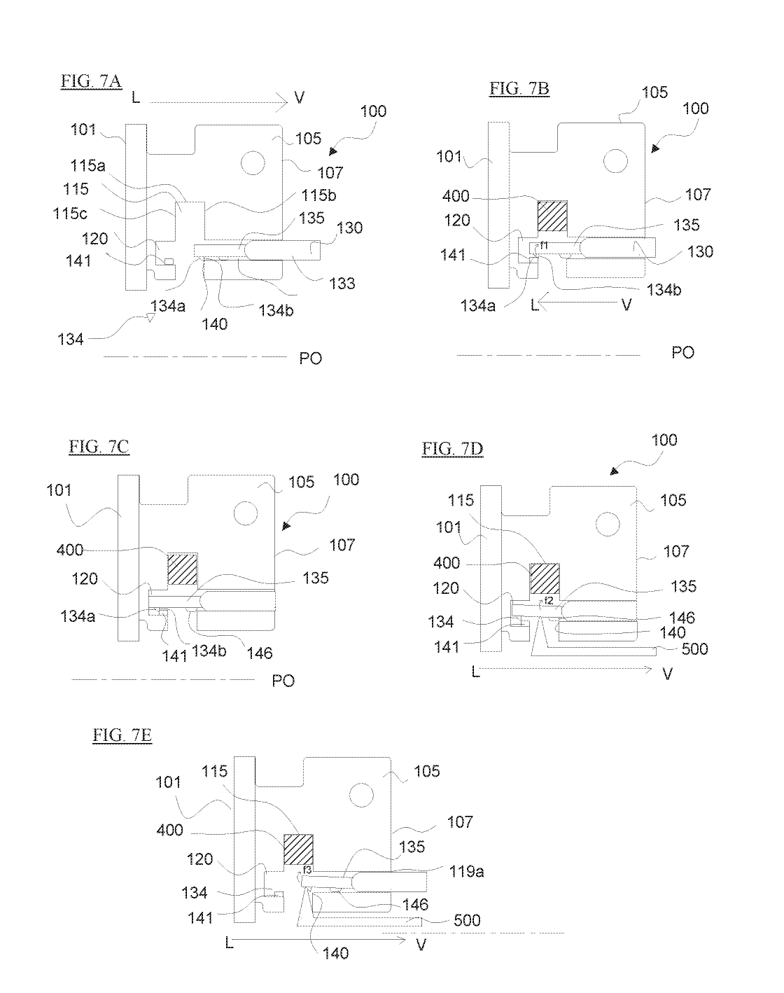

The central arm 135, 235 of the movable element 130, 230 has, by way of locking and holding means 134, 234, one or more lugs provided at its free end (FIGS. 1B, 2B, 6, 7, 11). Preferably, two lugs 134′, 134″ are provided. They are however considered to be the components of one and the same locking and holding means 134 (FIG. 11). Each lug, such as the lug 134, 234, projects from the bottom face of the arm 135, 235, that is to say from the face that is situated opposite to the bottom wall 115a, 215a of the groove 115, 215 when the movable element 130, 230 is in the closing position (FIGS. 6, 7). The lug 134, 234 has a guide surface 134a, 234a and a holding surface 134b, 234b that are intended to cooperate with stops on the body 105, 205 in the closing and opening positions. The holding surface 134b, 234b is perpendicular to the face of the arm 135, 235 from which it projects. The guide surface 134a, 234a forms an acute angle with the face of the arm 135, 235 from which it projects and converges towards the holding surface 134b, 234b.

In the position of opening the groove 115, 215, the movable closing element 130, 230 only partly projects from the anterior face 107, 207 of the body 105, 205. Access to the groove is left free and a dental archwire can be inserted therein (FIGS. 3, 4, 6A, 7A). The holding surface 134b, 234b of the lug 134, 234 encounters a stop 140, 240 provided at the entrance 119b, 219b to the passage 119, 219 (FIGS. 6A, 7A). The movable closing means 130, 230 is then stopped in its travel, which it cannot continue in the lingual-vestibular direction. The opening position is maintained. It cannot thereby fall into the mouth of the patient. The stop 140, 240 is formed by an edge of the entrance 119b, 219b of the passage 119, 219. However, any other stop configuration at the entrance 119b, 219b is envisaged.

Once the dental archwire 400 is housed in the groove 115, 215, the movable closing element 130, 230 is moved manually in the vestibular-lingual direction until it reaches the closing position (FIGS. 5, 6B, 7B, 7C).

During the movement, the lug 134, 234 encounters a stop 141, 241 provided in the housing 120, 130. The guide surface 134a, 234a faces the stop 141, 241. Since this surface is inclined, a slight thrust force exerted on the movable element 130, 230 produces a bending of the free end of the central arm 135, 235 in a direction extending outside the plane containing said arms and upwards (see arrow f1, FIG. 7B), enabling the guide surface 134a, 234a to slide along the stop 141, 241 in order to pass it (FIGS. 7B, 7C).

In the position of closure of the groove 115 and 215, the free ends of the arms 132, 133 and 135 of the movable closing element 130, as well as the free ends of the arms 232, 233, 235 of the movable closing element 230, are housed in the housings 120 and 220 respectively (FIGS. 6B, 7C, 7D).

In this closing position, the anterior wall 131, 231 of the closing means 130, 230 fits flush with the anterior face 107, 207 of the body 105, 205. Thus, in this closing position, the face 107, 207 has a completely smooth appearance (FIGS. 1A and 2A, 6B, 7C).

It should be noted that the movable closing element 130, 230 closes the groove 115, 215 by means of its arms 132, 232, 133, 233 and 135, 235 and that the empty spaces existing between these arms consequently limits the friction surface between the movable closing element 130, 230 and the archwire 400. Furthermore, the central arm 135, 235 has a thickness less than that of the arms 132, 232 and 133, 233 and is not in contact with the archwire 400.

The movable element 130, 230 is locked in the closing position by means of the lug 134, 234. The holding surface 134b, 234b of the lug 134, 234 encounters the stop 141, 241 of the housing 120, 130. The movable closing means 130, 230 is then locked and cannot move in the lingual-vestibular direction. It also cannot move in the vestibular-lingual direction, the free ends of the arms of the movable element 130, 230 being placed against the bottom wall 121, 221 of the housing 120, 220 (FIGS. 6B, 7C). To this end, the distance between the holding surface of the lug 134, 234 and the free end of the arm 135, 235 is equal to the distance separating the stop 141, 241 from the bottom wall 121, 221.

The passage of the movable closing element 130 from the closing position to the opening position is achieved by means of a manipulation tool 500 designed to exert a force on the central arm 135 so as to raise the free end in a direction opposite to the stop 141 towards the top face 112 and to pull it in the lingual-vestibular direction (FIG. 7D). The pressure exerted by the tool 500 produces in fact a bending of the central arm 135 out of the plane containing the arms 132, 133 and 135 (arrow f2). The lug 134 can thus pass the stop 141.

When the practitioner wishes to completely remove the movable closing element 130, for example in order to replace it, the passage of the lug 134 beyond the stop 140 is achieved in an identical manner to the passage of the stop 141, by means of the same tool 500, by applying a force f3 with components identical to the force f2 (FIG. 7E), that is to say in a direction opposite to the stop 140 towards the top face 112 and in the lingual-vestibular direction. The movable element 130 can then follow the passage 119 until it emerges therefrom through the opening 119a.

The movement of the movable closing element 230 and the passage of the lug 234 beyond the stops 240 and 241 is achieved in an identical manner to what has just been described concerning the movable closing element 130.

To facilitate the gripping by the manipulation tool 500 of the movable element 130, 230, the latter has attachment or gripping means that are provided on the central arm 135, 235. For example, the attachment or gripping means are in the form of hollows or recesses, one of them, such as the hollow 142, passing through the anterior wall 131, 231 of the movable element 130, 230 and the other one 143, 243 formed in the free end of the central arm 135, 235 (FIGS. 1B, 2B, 11). Such means allow the insertion of the point or end piece of the tool 500. The attachment means 143, 243 enables the tool to exert a force f2 in order to dislodge the free end of the central arm 135, 235 from the housing 120, 220. The attachment means 142, 242 enables the tool 500 to exert the force f3 in order to dislodge the free end of the central arm 135, 235 from the housing 120, 220. To enable the tool 500 to reach these attachment or gripping means, passages such as the passages 244 and 243 in the body 205 are provided (FIG. 5).

Lateral arms 132, 232 and 133, 233 of the movable closing element 130, 230 serve as a guide inside the passages 119, 219 during movements. It has two lateral faces 132a, 232a and 133a, 233a (FIGS. 2A, 2B, 11). According to the first embodiment, the distance between the two lateral faces 132a, 133a of the movable element 130 is equal to the distance between the two lateral faces 109 and 110 of the body 105. According to the second embodiment, the distance between the two lateral faces 232a, 233a of the movable element 230 is at least equal to 90% of the distance between the two lateral faces 209 and 210 of the body 205. Consequently the movable element extends entirely or almost entirely from one lateral face 109, 209 of the body 105, 205 to other one 110, 210. This feature increases the stability of the brace 100, 200 during treatment and movement along the orthodontic archwire. Furthermore, the groove 115, 215 is closed over the entire length.

The lateral arms 232 and 233 of the movable element 230 of the self-ligating brace 200 have a round cross-section (FIG. 2B).

The passage 219 formed in the anterior portion 218 of the body 205 has a cross-section complementary to the cross-section of the movable element 230 and is closed laterally (FIG. 8).

It further comprises pillars 222 and 223 provided for separating the passage 219 into three sections 2191, 2192 and 2193 receiving respectively the three arms 232, 233 and 235. This feature increases the stability of the movable element 230 and reduces the risks of rubbing.

The lateral arms 232 and 233 follow respectively the sections 2192 and 2191 of the passage 219.

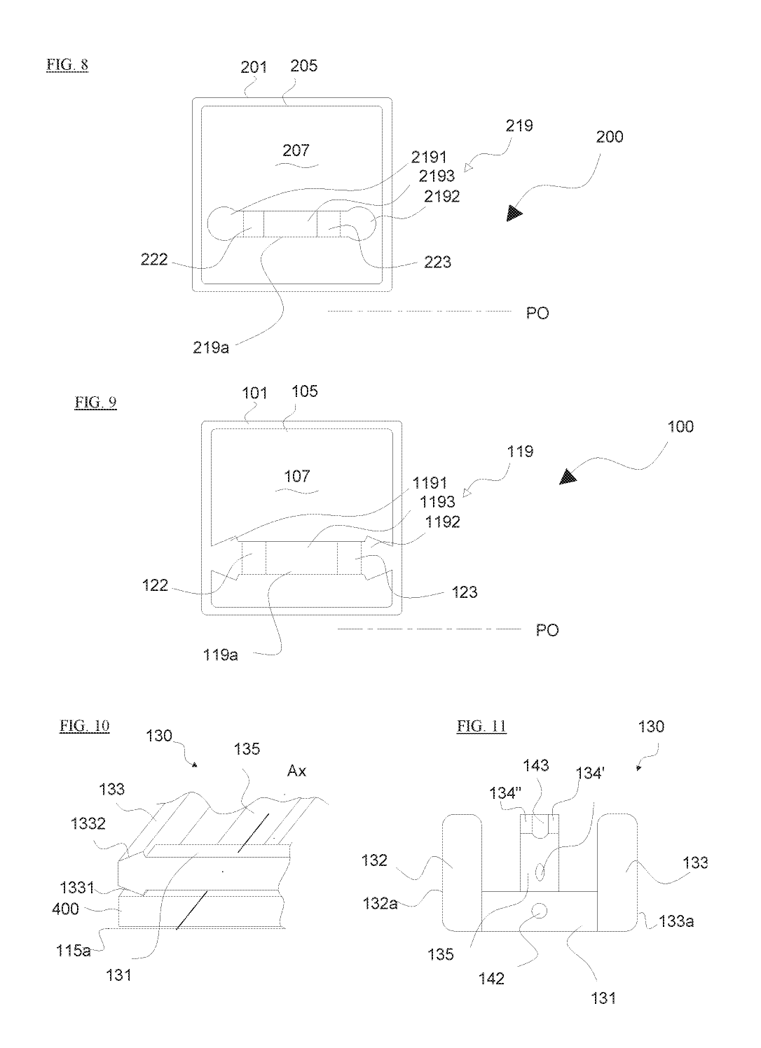

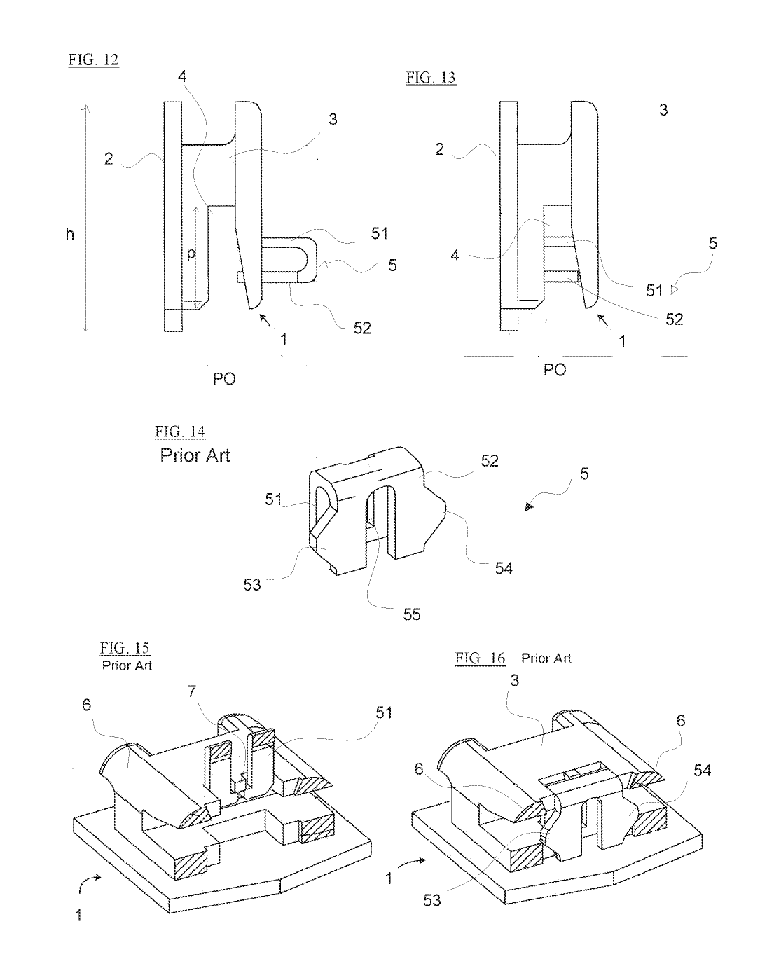

The lateral arms 132 and 133 of the movable element 130 of the self-ligating brace 100 have six faces, including a face, such as the face 1331, situated opposite the bottom wall of the groove 115a when the movable element 130 is in the closing position and a face 1332 opposite the face 1331, these said faces converging towards each other in a direction extending from the longitudinal median axis (Ax) of the movable element 130 in the direction of the outside (FIG. 10).

This embodiment is advantageous since the contact between the arms 132, 133 and the orthodontic archwire 400 is reduced to points, which reduces the phenomena of rubbing.

The passage 119 formed in the anterior portion 118 of the body 105 receiving the movable element 130 has a cross-section complementary to the cross-section of the movable element 130 (FIG. 9). Pillars 122 and 123 are also provided for separating the passage 119 into three sections 1191, 1192 and 1193 receiving respectively the three arms 132, 133 and 135.

It should be noted that the passage 119 is open laterally, that is to say it merges laterally on the lateral faces 109 and 110 of the body 105. Since the distance between the two lateral faces 132a, 133a of the movable element 130 is equal to the distance between the two lateral faces 109 and 110 of the body 105, the lateral arms 132 and 133 fit flush with the lateral faces 109 and 209. This feature also limits the friction of the movable element 130 in the body 105 and improves the comfort of the patient.

Optionally, a pattern in relief 146, 246 can be provided, projecting from the face of the arm 135, 235 that is situated opposite the bottom wall 115a, 215a of the groove 115, 215 in the closing position. The pattern in relief 146, 246 is intended to encounter the stop 140, 240 at the entrance 119b, 219b of the passage 119, 219 when the movable element 130, 230 is in the closing position (FIGS. 6B, 7C) so as to strengthen as required the locking of the movable element 130, 230 in the closing position.

Advantageously again, the anterior portion 118, 218 of the body 105, 205 has a secondary passage 150, 250 passing through it, with a cross-section that is preferentially cylindrical or round, extending from one lateral face 109, 209 and 110, 210 of the body 105, 205 to the other, for passage of a secondary wire 450.

The self-ligating braces 100 and 200 can be produced from metal, ceramic or plastics material, or any other material suitable for the use of these braces.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-18. (canceled)

19. A self-ligating orthodontic brace comprising:
a base having a face for fixing to the surface of a tooth,
a body extending from the base, having an anterior face opposite to the fixing face, and two lateral faces,
a groove configured to receive an orthodontic archwire, the groove being delimited by a bottom wall and two lateral walls, the groove passing right through the body from one of its lateral faces to the other, and having an opening emerging in a direction of the occlusal plane when said brace is fixed to a tooth,
a movable element for closing the groove, the movable element being configured to move in translation between a position of closing the groove, in which the movable element closes off access to said groove, and an opening position, in which the movable element releases access to said groove,
the body comprising a posterior position connected to the base and an anterior portion that is opposite the base with respect to said groove, and through which a passage is provided for said movable element, the passage comprising an opening accessible from the anterior face of the body and an opening emerging in the direction of the groove,
the movable closing element being configured to move in translation in the vestibular-lingual axis inside said passage and having an anterior wall from which there extend, in the same plane, two lateral arms serving as a guide for the movable element inside said passage and at least one central arm which comprises a lock for the movable element in the position of closure of the groove, in which an anterior wall of the movable element fits flush with the anterior face of the body and a holder for the movable element in the opening position in which the movable element only partly projects from the anterior face of the body, said lock and said holder being the same.

20. The self-ligating orthodontic brace according to claim 19, wherein said posterior portion has one or more housings having an opening emerging in the direction of said groove and configured to house the free ends of said arms when the movable closing element is in the closing position.

21. The self-ligating orthodontic brace according to claim 19, wherein the central arm of the movable element comprises, by way of the lock and holder, at its free end, at least one lug projecting from a face opposite to the bottom wall of the groove in the direction of the occlusion plane, each lug having a guide surface that is configured to cooperate with stops on the body so as to guide the movable element from the opening position to the closing position, and a holding surface that is configured to cooperate with said stops so as to lock and hold the movable element in the closing position or in the opening position.

22. The self-ligating orthodontic brace according to claim 21, wherein at least one of the stops with which the lug or lugs cooperate in the closing position is provided in the housing of the body.

23. The self-ligating orthodontic brace according to claim 21, wherein at least one of the stops with which the lug or lugs cooperates in the opening position is provided at the entrance of the passage that emerges in the groove.

24. The self-ligating orthodontic brace according to claim 19, wherein the movable closing element has at least one surface configuration to allow attachment or gripping by a manipulation tool.

25. The self-ligating orthodontic brace according to claim 24, wherein the surface configuration is provided on the central arm.

26. The self-ligating orthodontic brace according to claim 24, wherein the movable closing element has two surface configurations, in the form of hollows or recesses, one passing through the anterior wall of the movable closing element, the other formed in the free end of the central arm.

27. The self-ligating orthodontic brace according to claim 19, wherein the movable closing element has two lateral faces, the distance between these two faces being at least equal to 90% of the distance between the two lateral faces of the body.

28. The self-ligating orthodontic brace according to claim 19, wherein said lateral arms of the movable element have a round cross-section.

29. The self-ligating orthodontic brace according to claim 19, wherein each lateral arm of the movable element has a plurality of faces, including one face situated opposite the bottom wall of the groove when the movable element is in the closing position, and a face opposite thereto, these faces converging towards each other in a direction extending from the longitudinal median axis of the movable element in the direction of the outside.

30. The self-ligating orthodontic brace according to claim 19, wherein the passage formed in the anterior portion of the body has a cross-section complementary to the cross-section of the movable element.

31. The self-ligating orthodontic brace according to claim 19, wherein the passage formed in the anterior portion is closed laterally.

32. The self-ligating orthodontic brace according to claim 19, wherein the passage formed in the anterior portion is open laterally.

33. The self-ligating orthodontic brace according to claim 19, wherein the part of the groove receiving the orthodontic archwire has a round, square or rectangular cross-section.

34. The self-ligating orthodontic brace according to claim 19, wherein the anterior portion of the body has a secondary passage with a preferentially round cross-section passing through it, extending from one lateral face of the body to the other, for passage of a secondary wire.

35. The self-ligating orthodontic brace according to claim 19, wherein the body has surface configurations to allow the attachment or fixing of dental movement devices other than the dental archwire.

36. A set of self-ligating orthodontic braces, comprising at least two self-ligating orthodontic braces, wherein each brace comprises:
a base having a face for fixing to the surface of a tooth,
a body extending from the base, having an anterior face opposite to the fixing face, and two lateral faces,
a groove configured to receive an orthodontic archwire, the groove being delimited by a bottom wall and two lateral walls, the groove passing right through the body from one of its lateral faces to the other, and having an opening emerging in a direction of the occlusal plane when said brace is fixed to a tooth,
a movable element for closing the groove, the movable element being configured to move in translation between a position of closing the groove, in which the movable element closes off access to said groove, and an opening position, in which the movable element releases access to said groove,
the body comprising a posterior position connected to the base and an anterior portion that is opposite the base with respect to said groove, and through which a passage is provided for said movable element, the passage comprising an opening accessible from the anterior face of the body and an opening emerging in the direction of the groove,
the movable closing element being configured to move in translation in the vestibular-lingual axis inside said passage and having an anterior wall from which there extend, in the same plane, two lateral arms serving as a guide for the movable element inside said passage and at least one central arm which comprises a lock for the movable element in the position of closure of the groove, in which an anterior wall of the movable element fits flush with the anterior face of the body and a holder for the movable element in the opening position in which the movable element only partly projects from the anterior face of the body, said lock and said holder being the same.
